(19) United States
(12) Patent Application Publication
(10) Pub. No.: US 2025/0277396 A1
(43) Pub. Date: Sep. 4, 2025

(54) DOOR ASSEMBLY

(71) Applicant: TEREX SOUTH DAKOTA, INC., Watertown, SD (US)

(72) Inventors: Ankith RAVISHANKAR, Bengaluru (IN); Yogesh RJ, Bengaluru (IN); Prathap MURALIDHARA, Bengaluru (IN); Abin PETER, Bengaluru (IN); Charles SUNNY, Bengaluru (IN)

(73) Assignee: TEREX SOUTH DAKOTA, INC., Watertown, SD (US)

(21) Appl. No.: 18/593,586

(22) Filed: Mar. 1, 2024

(51) Int. Cl. E05D 7/10; B66F 11/04; E05D 3/02

(52) U.S. Cl. CPC E05D 7/1011; B66F 11/046; E05D 3/02; E05Y 2900/531

(57) ABSTRACT

A door assembly according to the disclosure may comprise a hinge; a door holder attached to the hinge, wherein the door holder defines a first opening; a door having a support that is receivable in the door holder, wherein the support defines a second opening that is alignable with the first opening when the support is positioned in the door holder; and a locking device that is insertable into the second opening when the support is positioned in the door holder and the second opening is aligned with the first opening to lock the door to the door holder. The locking device is removable from the second opening by pulling on at least a portion of the locking device so that the support may be removed from the door holder.

### TECHNICAL FIELD

The disclosure relates to a door assembly.

### BACKGROUND

An example door assembly is disclosed in U.S. Pat. No. 8,016,074 B2.

### SUMMARY

A door assembly according to the disclosure may comprise a hinge; a door holder attached to the hinge, wherein the door holder defines a first opening; a door having a support that is receivable in the door holder, wherein the support defines a second opening that is alignable with the first opening when the support is positioned in the door holder; and a locking device that is insertable into the second opening when the support is positioned in the door holder and the second opening is aligned with the first opening to lock the door to the door holder. The locking device is removable from the second opening by pulling on at least a portion of the locking device so that the support may be removed from the door holder.

While exemplary embodiments are illustrated and disclosed, such disclosure should not be construed to limit the claims. It is anticipated that various modifications and alternative designs may be made without departing from the scope of the disclosure.

### BRIEF DESCRIPTION OF THE DRAWINGS

FIG. 1 is a perspective view of a lift with a work platform assembly including a door assembly according to disclosure, wherein the lift is shown in a lowered position;

FIG. 2 is a perspective view of the lift of FIG. 1 shown in a raised position;

FIG. 3A is a perspective view of the work platform showing two doors of the door assembly each in a use position;

FIG. 3B is a perspective view of the work platform of FIG. 3A showing the doors unlocked from the work platform assembly and removed from the work platform assembly;

FIG. 4 is an enlarged perspective view of a first door holder of the door assembly and a first support of a door received in the first door holder, wherein the first door holder is attached to a first hinge which is attached to a frame member of a frame assembly of the work platform assembly;

FIG. 5 is an enlarged perspective view of a second door holder of the door assembly and a second support of the door received in the second door holder, wherein the second door holder is attached to a second hinge which is attached to the frame member of the frame assembly;

FIG. 6A is a cross-sectional view of the first door holder and the first support of the door received in the first door holder, and showing a locking device in a locking position for securing the first support to the first door holder;

FIG. 6B is a cross-sectional view similar to FIG. 6A showing the locking device in a released position, and the first support of the door being removed from the first door holder;

FIG. 7A is an enlarged side view of the locking device, partially in section, in the locking position;

FIG. 7B is an enlarged side view of the locking device, partially in section, in the released position;

FIG. 8 is an enlarged side view of another embodiment of a locking device for locking the first support of the door to the first door holder;

FIG. 9A is a perspective similar to FIG. 4 showing a portion of another embodiment of door assembly according to the disclosure, including additional example embodiments of a door holder, a support portion of a door received in the door holder, and a locking device for securing the support portion to the door holder;

FIG. 9B is an exploded perspective view of the portion of the door assembly of FIG. 9A showing the support portion of the door removed from the door holder, and the locking device removed from the support portion and the door holder; and

FIG. 10 is a side view of the locking device shown in FIGS. 9A and 9B.

### DETAILED DESCRIPTION

As required, detailed embodiments are disclosed herein. However, it is to be understood that the disclosed embodiments are merely exemplary, and that various and alternative forms may be employed. The figures are not necessarily to scale; some features may be exaggerated or minimized to show details of particular components. Therefore, specific structural and functional details disclosed herein are not to be interpreted as limiting, but merely as a representative basis for teaching one skilled in the art.

As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including.” “comprises” and/or “comprising” specify the presence of stated features, integers, steps, operations, elements, and/or components, but do not preclude the presence or addition of one or more other features, integers, steps, operations, elements, components, and/or groups thereof.

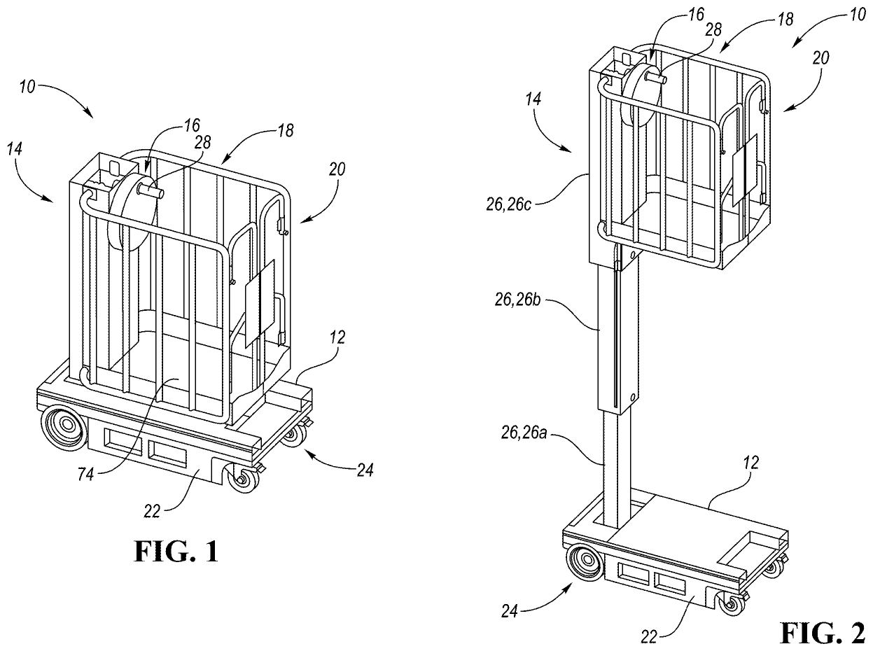

FIGS. 1 and 2 show an example lift device or lift 10 according to the disclosure, such as a boom lift or aerial work platform. The lift 10 includes a base 12, a support member arrangement 14 attached to the base 12, a drive system 16 that is operable to move the support member arrangement 14 between a lowered position, shown in FIG. 1, and a raised position, shown in FIG. 2, and a work platform assembly 18 connected to the support member arrangement 14 and configured to receive an operator, wherein the work platform assembly 18 includes a novel door assembly 20 (e.g., gate assembly) according to the disclosure as explained below in detail.

The base 12 of the lift 10 shown in FIGS. 1 and 2 is configured to support the support member arrangement 14, along with the rest of the lift 10, and includes a main body 22, such as a rigid support structure, and one or more support members 24, such as wheels, tracks, outriggers, etc., attached to the main body 22. In the illustrated embodiment, the lift 10 includes multiple support members 24 formed as wheels and associated tires, so that the base 12 is movable. Furthermore, two or more of the wheels are pivotable in order to steer the base 12.

The support member arrangement 14 may include one or more movable support members 26, such as pivotable and/or linearly movable booms, masts, tubes, columns, arms, etc., attached to the base 12. In the illustrated embodiment, the support member arrangement 14 includes first, second and third upright support members 26a, 26b and 26c, respectively, and the second and third upright support members 26b and 26c, respectively, are linearly movable with respect to the first upright support member 26a when the support member arrangement 14 moves between the lowered and raise positions. In another embodiment, the support member arrangement 14 may include two upright support members, wherein one of the upright support members may be movable with respect to the other upright support member.

The drive system 16 may have any suitable configuration that is operable to move one or more of the support members 26 in order to move the support member arrangement 14 between the lowered and raised positions. For example, the drive system 16 may include one or more drive members, such as cylinders (e.g., hydraulic and/or electric cylinders), flexible drive members (e.g., strands, belts, chains and/or cables), rigid drive members (e.g., rack and pinion systems, rotatable shafts and gears), etc., and one or more actuators, such as automatic actuators (e.g., electric motors or pumps) and/or manually operable (i.e., hand-operated) actuators. In an embodiment including an automatic actuator, the actuator may be operable to move one or more drive members formed as cylinders between retracted and extended positions, for example. In the illustrated embodiment, the drive system 16 includes a manually operated actuator 28, which may include a rotatable member, such as a wheel, disc, hand crank, lever arm, etc., that is configured to move one or more drive members, such as through transmission system including a gear system (not shown). Examples of a lift including a manual operable actuator or an automatic actuator are disclosed in U.S. application Ser. No. 18/593,237 (corresponding to Attorney Docket TERS 0147 PUS) filed on Mar. 1, 2024, which is hereby incorporated by reference in its entirety.

Referring to FIGS. 1-3B, the work platform assembly 18 is movable with the support member arrangement 14 when the support member arrangement 14 moves between the lowered and raised positions. The work platform assembly 18 includes a base or work platform 30 (e.g., flat work platform) sized to receive and support an operator thereon, and a frame assembly 32, such as a railing assembly, provided on the platform 30. In the illustrated embodiment, the frame assembly 32 extends around, or partially around, a perimeter of the platform 30, and includes multiple frame members, such as toe boards 34, horizontal rails 36, and vertical or upright rails 38, which are connected to the toe boards 34 and the horizontal rails 36. As mentioned above, the work platform assembly 18 also includes the door assembly 20, which is connected to the frame assembly 32. Furthermore, at least a portion of the frame assembly 32 may be considered part of the door assembly 20.

Alternatively, the door assembly 20 may be used with any suitable lift having any suitable configuration, such as a scissor lift, articulated boom lift, straight boom lift, etc. Furthermore, any lift with which the door assembly 20 may be used may be a manual lift (e.g., manually operated lift) or an automatic lift, such as a hydraulic lift or electric lift.

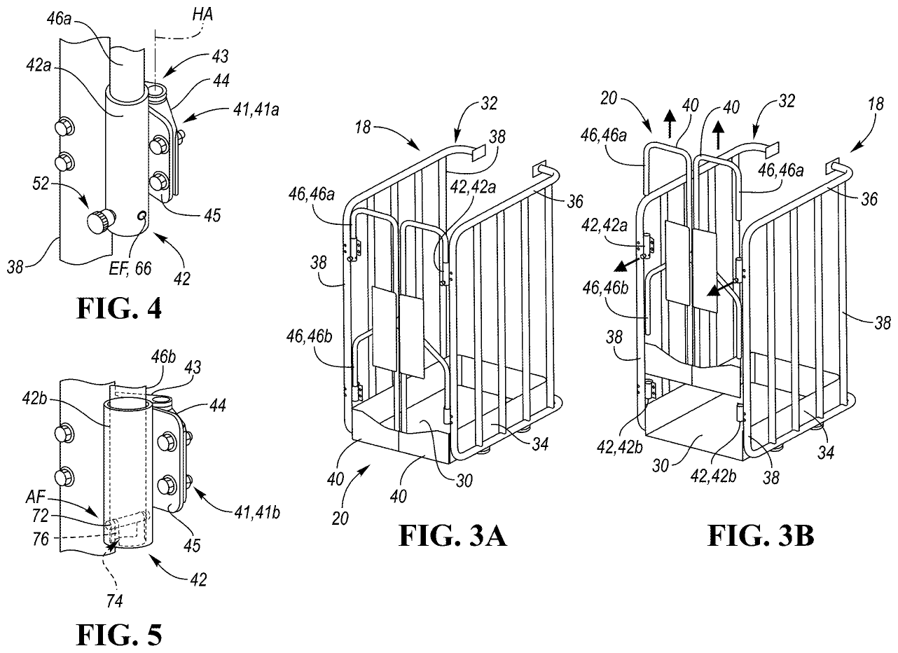

While the door assembly 20 may include one door (e.g., gate) or multiple doors (e.g., gates), in the illustrated embodiment, the door assembly 20 includes two doors 40 that are each connected to a respective frame member, such as an upright rail 38 positioned adjacent the door 40 and which may be referred to as a side rail. Referring to FIGS. 3A-5, the door assembly 20 also includes one or more hinges 41 connected to each upright rail 38 positioned adjacent to each of the doors 40, and a door holder 42 connected to each of the hinges 41. For example, each hinge 41 includes a fixed hinge part 43 fixedly connected to a respective upright rail 38, such as with one more suitable fasteners (e.g., screws, bots, nuts, etc.), and a movable hinge part 44 that is pivotally connected to the fixed hinge part 43 so that the movable hinge part 44 is pivotable about a hinge axis HA of the hinge 41. Furthermore, each door holder 42 is fixedly connected to a respective movable hinge part 44 so that the door holder 42 is movable (e.g., pivotable) with the hinge part 44 about the hinge axis HA. For example, each door holder 42 may include a projecting portion 45 (e.g., tab) that extends from a main body of the door holder 42 and is connected to the hinge part 44 with one or more suitable fasteners (e.g., screws, bots, nuts, etc.).

In the illustrated embodiment, the door assembly 20 includes two hinges 41 and two door holders 42 for each door 40, and each door 40 is movable (e.g., pivotable) between a closed position shown in FIG. 3A and an open position (not shown) for allowing access to the work platform assembly 18. More specifically, the door assembly 20 includes a first or upper hinge 41a and an associated first or upper door holder 42a, and a second or lower hinge 41b and an associated second or lower door holder 42b for each door 40, and each door 40 is pivotable inwardly from the closed position to the open position. Furthermore, each door 40 includes multiple support portions or supports 46 that are each receivable in one of the door holders 42. For example, each door 40 may include an upper support 46a that is insertable into or receivable in an upper door holder 42a, and a lower support 46b that is insertable into or receivable in a lower door holder 42b.

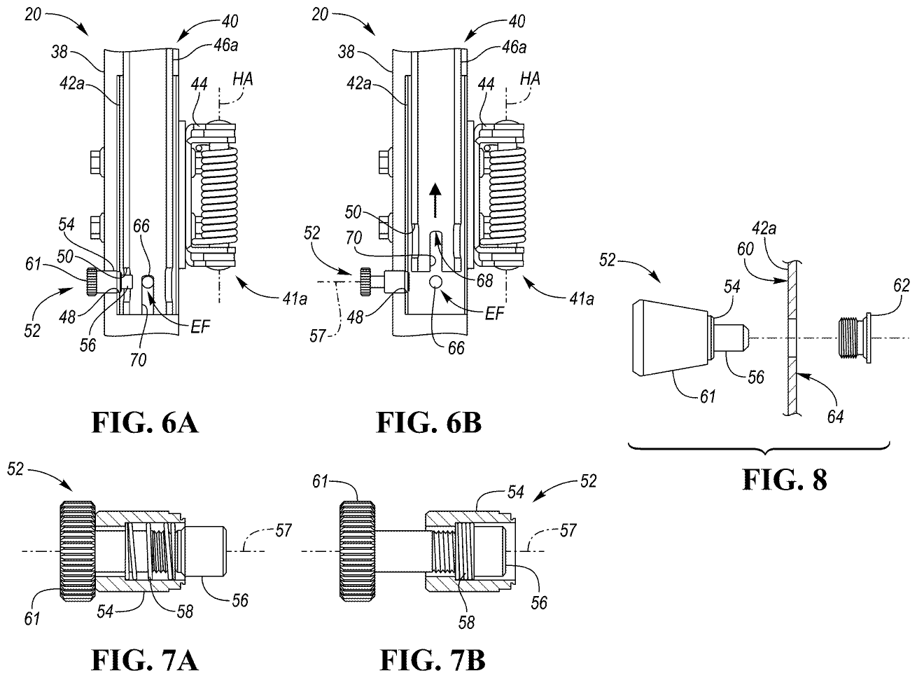

One or both of the door holders 42 for each door 40 may be configured as a quick-release door holder. In the illustrated embodiment, for example, each upper door holder 42a is configured as a quick-release door holder. In that regard, referring to FIGS. 6A-6B, each upper door holder 42a defines a first opening 48 that is alignable with a second opening 50 formed in a respective upper support 46a of a respective door 40, and the door assembly 20 further includes a locking device 52 that is insertable into the second opening 50 (e.g., movable to a locking position shown in FIG. 6A) when the upper support 46a is positioned in the upper door holder 42a and the second opening 50 is aligned with the first opening 48 to lock the upper support 46a and the associated door 40 to the upper door holder 42a. Furthermore, referring to FIGS. 3B and 6B, the locking device 52 is removable from the second opening 50 (e.g., movable to a released or retracted position) by pulling on the locking device 52, or a portion of the locking device 52, so that the upper support 46a may be removed from the upper door holder 42a to thereby remove the door 40 from the work platform assembly 18.

In the embodiment shown in FIGS. 6A-7B, each locking device 52 comprises a first portion, such as an outer body 54, that is engageable with the upper door holder 42a, a second portion, such as an inner portion 56 (e.g., a rod, pin, plunger, etc.) configured for insertion into the second opening 50, and a biasing member 58, such as a coil spring, helical spring, or any other suitable spring, that urges the inner portion 56 into the second opening 50 when the upper support 46a is positioned in the upper door holder 42a. The inner portion 56 is movable along a longitudinal axis 57 of the locking device 52 between a locking position in which the inner portion 56 is inserted into the second opening 50 as shown in FIG. 6A, and a released or retracted position in which the inner portion 56 is removed from the second opening 50 as shown in FIG. 6B. Each locking device 52 may also include a grip portion 61 attached to the inner portion 56, and the grip portion 61 may be gripped by a user and pulled away from the upper door holder 42a in order to move the inner portion 56 from the locking position to the released position. For example, each locking device 52 may be formed as a spring-loaded plunger.

Furthermore, the outer body 54 may be secured to the upper door holder 42a in any suitable manner. In the embodiment shown in FIG. 6A-7B, for example, the outer body 54 is configured to be press fit into the first opening 48 of the door holder 42a so that the outer body 54 is connected to the upper door holder 42a by an interference fit. Furthermore, the outer body 54 may be made of any suitable material, such as metal (e.g., steel, stainless steel, aluminum, etc.), plastic or a composite material, configured to form an interference fit (e.g., configured to plastically deform) when the outer body 54 is pressed into the first opening 48 of the door holder 42a. As another example, the outer body 54 may be fastened to the upper door holder 42a with a fastener. In the embodiment shown in FIG. 8, for example, the outer body 54 is engageable with an outer surface 60 of the upper door holder 42a, the locking device 52 further includes a sleeve 62 that is engageable with an inner surface 64 of the upper door holder 42a, and the sleeve 62 may be threadingly connectable to the outer body 54 to secure the outer body 54 to the upper door holder 42a.

Returning to FIGS. 6A and 6B, the door assembly 20 may be configured so that, for each door 40, the upper door holder 42a and the upper support 46a of the door 40 each comprise an engagement feature EF, and the engagement features EF are engageable with each other when the upper support 46a is positioned in the upper door holder 42a so that the upper door holder 42a supports at least a portion of a weight or mass of the door 40. With such a configuration, the door assembly 20 may be configured so that, for each door 40, no weight or mass of the door 40 rests on the associated locking device 52 when the locking device 52 is inserted into the second opening 50 of the upper support 46a. As a result, the locking device 52 may be easily removed from the second opening 50 by pulling outwardly on at least a portion (e.g., the grip portion 61) of the locking device 52. For example, the engagement feature EF of one of the upper door holder 42a and the upper support 46a may comprise an engagement member, such as a projection, pin, etc., and the engagement feature EF of the other of the upper door holder 42a and the upper support 46a may comprise a receptacle, such as a slot, notch, groove, etc., that receives the engagement member when the upper support 46a is positioned in the upper door holder 42a. In the embodiment shown in FIGS. 6A and 6B, the engagement feature EF of the upper door holder 42a comprises a pin 66 positioned proximate a lower end of the upper door holder 42a, and the engagement feature EF of the upper support 46a comprises an engagement surface 68 that at least partially defines a slot 70 at a lower end of the upper support 46a, wherein the slot 70 is configured to receive the pin 66 and the engagement surface 68 is engageable with the pin 66 when the upper support 46a is positioned in the upper door holder 42a. In the embodiment shown in FIGS. 4, 6A and 6B, the pin 66 is oriented in a direction transverse to the longitudinal axis 57 of the locking device 52 when the upper support 46a is positioned in the upper door holder 42a and the locking device 52 is inserted the second opening 50.

For each door 40, the engagement features EF of the upper door holder 42a and the upper support 46a may also, or instead, function as alignment features. In that regard, the engagement features EF may be cooperable with each other to align the first opening 48 and the second opening 50 when the upper support 46a is positioned in the upper door holder 42a. In addition, the engagement features EF may be cooperable with each other so that the upper door holder 42a and the upper support 46a are movable together with respect to the hinge axis HA of the associated hinge 41a. In the embodiment shown in FIGS. 6A and 6B, for example, the pin 66 and the engagement surface 68, which defines the slot 70, cooperate with each other to align the openings 48 and 50 when the upper support 46a is positioned in the upper door holder 42a. Likewise, the pin 66 and the engagement surface 68 are engageable with each other so as to fix together the upper door holder 42a and the upper support 46a so that the upper door holder 42a and the upper support 46a are movable, e.g., pivotable, together along with the hinge part 44 and with respect to the hinge axis HA of the associated hinge 41a.

Referring to FIGS. 3A, 3B and 5, the door assembly 20 may be configured so that, for each door 40, the lower door holder 42b and the lower support 46b of the door 40 each comprise an alignment or securing feature AF, and the alignment features AF are cooperable with each other when the lower support 46b is positioned in the lower door holder 42b so that the lower door holder 42b and the lower support 46b are movable (e.g., pivotable) together along with the associated hinge part 44 and with respect to the hinge axis HA of the associated hinge 41b. For example, the alignment feature AF of one of the lower door holder 42b and the lower support 46b may comprise an alignment member, such as a projection, pin, etc., and the alignment feature AF of the other of the lower door holder 42b and the lower support 46b may comprise a receptacle, such as a slot, notch, groove, etc., that receives the alignment member when the lower support 46b is positioned in the lower door holder 42b. In the embodiment shown in FIG. 5, the alignment feature AF of the lower door holder 42b comprises a pin 72 positioned proximate a lower end of the lower door holder 42b, and the alignment feature AF of the lower support 46b comprises an engagement surface 74 that at least partially defines a slot 76 at a lower end of the lower support 46b, wherein the slot 76 is configured to receive the pin 72 and the engagement surface 74 is engageable with the pin 72 when the lower support 46b is positioned in the lower door holder 42b.

For each door 40, the alignment features AF of the lower door holder 42b and the lower support 46b may also be configured to support at least a portion of the weight or mass of the door 40.

With the above configuration, at least one of the door holders 42 for each door 40 of the door holder assembly 20 may be configured to cooperate with the respective support 46 of the door 40 to support at least a portion of the weight or mass of the door 40 so that no weight or mass of the door 40 is supported by the locking device 52. For example, the door holder 42a or the door holder 42b may support all of the weight or mass of the door 40, or each door holder 42a, 42b may support a portion of the weight or mass of the door 40 so that the door holders 42a and 42b together support all of the weight or mass of the door 40.

Furthermore, in another embodiment, the door assembly 20 may be configured so that the locking device 52 is provided with the lower door holder 42b. In yet another embodiment, a locking device 52 may be provided for each door holder 42a and 42b. In still yet another embodiment, the door assembly 20 may include a single door holder 42 for each door 40, and a single locking device 52 for use with the single door holder 42 to lock a support portion of the door 40 to the single door holder 42.

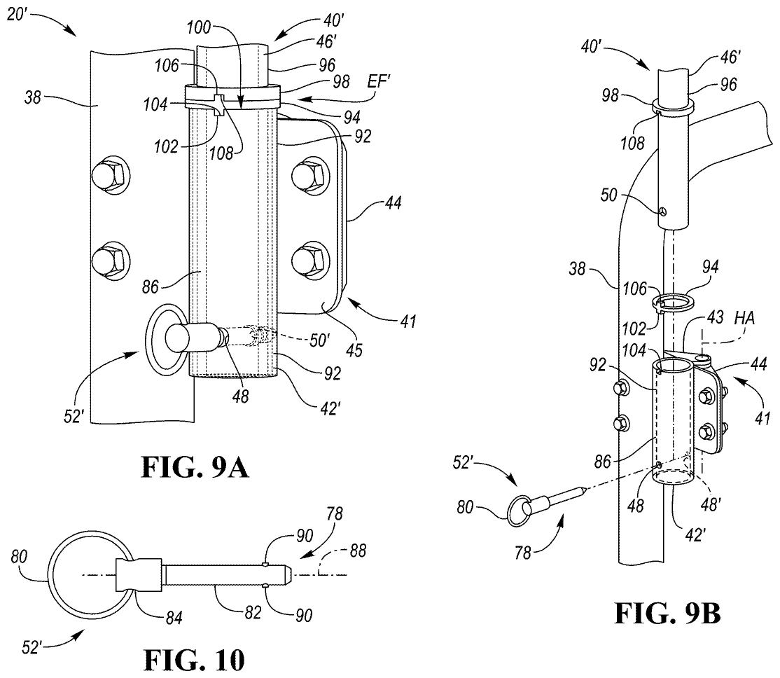

FIGS. 9A and 9B show a portion of another embodiment 20′ of a door assembly (e.g., gate assembly) according to the disclosure. The door assembly 20′ is similar to the door assembly 20 and may include the same or similar features as the door assembly 20, which features are identified with the same or similar reference numerals, but the reference numerals used to identify similar features in the door assembly 20′ may each include a prime mark. In that regard, the door assembly 20′ may include one or more doors 40′ (e.g., gates) that are each connected to a respective frame member, such as an upright rail 38 positioned adjacent the door 40′. Furthermore, each door 40′ may be connected to the respective upright rail 38 with one or more door holders 42′. The portion of the door assembly 20′ shown in FIGS. 9A and 9B includes a hinge 41 connected to the upright rail 38, an example door holder 42′, which may be an upper door holder or a lower door holder if the door assembly 20′ includes two door holders 42′ per door 40′, and a support portion or support 46′ of a door 40′ connected to the door holder 42′. In addition, the portion of the door assembly 20′ shown in FIGS. 9A and 9B includes another embodiment 52′ of a locking device that is insertable into a first opening 48 of the door holder 42′ and a second opening 50 of the support 46′ (e.g., movable to or positionable in a locking position shown in FIG. 9A), when the openings 48 and 50 are aligned with each other, in order to lock the support 46′ to the door holder 42′. The locking device 52′ may further be extendable through an additional first opening 48′ of the door holder 42′, which is positioned opposite the first opening 48, and an additional second opening 50′ of the support 46′, which is positioned opposite the second opening 50. With such a configuration, the locking device 52′ may extend through the door holder 42′ and the support 46′ when the locking device 52′ is in the locking position.

Referring to FIGS. 9A-10, the locking device 52′ includes a locking pin 78 and a pull member 80, such as a pull tab or ring, for removing the locking device 52′ (e.g., the locking pin 78) from the openings 48, 48′, 50, 50′ so that the support 46′ may be removed from the door holder 42′. The illustrated locking pin 78 comprises a pin body 82 having an enlarged head 84 that may be engageable with an outer surface 86 of the door holder 42′ when the locking device 52′ is in the locking position, and the pin body 82 may have a longitudinally extending pin axis 88. Furthermore, the illustrated locking pin 78 includes one or more lock elements 90, such as projections, balls, beads, etc., that are each movably associated with the pin body 82 so that the lock elements 90 are each movable in a direction transverse to the pin axis 88. In addition, the locking pin 78 includes one or more biasing members, such as coil or helical springs (not shown), positioned in the body 82 and configured to urge the lock elements 90 to each move in the direction transverse to the pin axis 88. With such a configuration, each lock element 90 may be biased outwardly by the one or more biasing members and away from the pin axis 88 when the locking device 52′ is inserted in the openings 48, 48′, 50, 50′ to hold the locking device 52′ in the locking position, and each lock element 90 may move inwardly toward the pin axis 88, and against the bias of the one or more biasing members, when the locking device 52′ is removed from the openings 48, 48′, 50, 50′.

In the embodiment shown in FIGS. 9A and 9B, the door holder 42′ and the support 46′ of the door 40′ each comprise an engagement feature EF′, and the engagement features EF′ are engageable with each other when the support 46′ is positioned in the door holder 42′ so that the door holder 42′ supports at least a portion of a weight or mass of the door 40′ so that the locking device 52′ does not support any weight or mass of the door 40′. With such a configuration, the locking device 52′ may be easily inserted into the openings 48, 48′, 50, 50′ to secure the door 40′ to the door holder 42′, and the locking device 52′ may be easily removed from the openings 48, 48′, 50, 50′ when it is desired to quickly remove the door 40′ from the door holder 42′, for example. In the illustrated embodiment, the door holder 42′ comprises a door holder body 92, and the engagement feature EF′ of the door holder 42′ comprises an engagement member 94, such as a washer, thrust washer, plate, etc., associated with the door holder body 92 (e.g., positionable on the door holder body 92 and/or attached to the door holder body 92). Likewise, the support 46′ comprises a support body 96 and the engagement feature EF′ of the support 46′ comprises a support member 98, such as a projection (e.g., tab, plate, etc.), that projects outwardly (e.g., radially outwardly) from the support body 96. For example, the support member 98 may be a plate, such as a circular or round plate, welded or otherwise attached to the support body 96. As another example, the engagement feature EF′ of the door holder 42′ may be a surface 100 (e.g., top surface) of the door holder body 92 that is directly engageable with the support member 98 of the support 46′.

The engagement features EF′ of the door holder 42′ and the support 46′ may also each include one or more alignment features for aligning the support 46′ with respect to the door holder 42′ (e.g., for aligning the openings 48, 48′, 50, 50′ with respect to each other) and/or for fixing the support 46′ with respect to the door holder 42′ so that the support 46′ and the door holder 42′ are pivotable together and with the movable hinge part 44 about the hinge axis HA of the hinge 41. For example, the door holder body 92 and the engagement member 94 of the door holder 42′ may each include a first alignment feature, and the first alignment features may be cooperable with each other for fixing the engagement member 94 with respect to the door holder body 92. In addition, the engagement member 94 of the door holder 42′ and the support member 98 of the support 46′ may each include a second alignment feature, and the second alignment features may be cooperable with each other for aligning the support 46′ with respect to the door holder 42′ and for fixing position of the support 46′ with respect to the door holder 42′ so that the support 46′ and the door holder 42′ are movable together. As a more detailed example, the door holder body 92 may include one of a first projection 102 (e.g., ridge, tab, pin, etc.) and a first receptacle 104 (e.g., recess, notch, groove, aperture, etc.), and the engagement member 94 may include the other of the first projection 102 and the first receptacle 104, and the first projection 102 and the first receptacle 104 may be engageable or otherwise cooperable with each other for fixing the engagement member 94 with respect to the door holder body 92. Likewise, the engagement member 94 may include one of a second projection 106 (e.g., ridge, tab, pin, etc.) and a second receptacle 108 (e.g., recess, notch, groove, aperture, etc.), and the support member 98 may include the other of the second projection 106 and the second receptacle 108, and the second projection 106 and the second receptacle 108 may be engageable or otherwise comparable with each other for aligning the support 46′ with respect to the door holder 42′ and for fixing position of the support 46′ with respect to the door holder 42′ so that the support 46′ and the door holder 42′ are movable together.

As another example, the locking device 52′ may be configured to fix position of the support 46′ with respect to the door holder 42′ so that the support 46′ and the door holder 42′ are movable together. In that regard, when the locking pin 78 is inserted in the openings 48, 48′, 50, 50′, the locking pin 78 may engage the door holder 42′ and the support 46′ and fix position of the support 46′ with respect to the door holder 42′.

As yet another example, the door 40′ may include an additional support and the door assembly 20′ may include an additional door holder configured to receive the additional support so that the additional door holder supports at least a portion of the weight or mass of the door 40′. In that regard, the additional door holder and the additional support may include any of the engagement features EF, EF′ discussed above in detail. Therefore, like the door assembly 20 described above, at least one of the door holder 42′ and the additional door holder of the door assembly 20′ may be configured to cooperate with the support 46′ or the additional support of the door 40′ to support at least a portion of the weight or mass of the door 40′ so that no weight or mass of the door 40′ is supported by the locking device 52′. For example, the door holder 42′ or the additional door holder may support all of the weight or mass of the door 40′, or each of the door holder 42′ and the additional door holder may support a portion of the weight or mass of the door 40′. Furthermore, the additional support and the additional door holder may include any of the alignment features described above for fixing position of the additional support with respect to the additional door holder.

With any of the above described door assembly embodiments, one or more doors may each be quickly and easily removed from an associated door holder by removing an associated locking device from an opening formed in a portion of the door (e.g., by simply pulling on at least a portion of the locking device) so that the door may be removed from the door holder. Likewise, each door may be quickly and easily reinstalled in the associated door holder by positioning the portion of the door in the associated door holder and reinserting the associated locking device into the opening of the door so that the door may be locked in a use position with respect to the door holder.

The following clauses describe aspects of embodiments according to the disclosure.

Clause 1. A door assembly according to the disclosure may comprise a hinge; a door holder attached to the hinge, wherein the door holder defines a first opening; a door having a support that is receivable in the door holder, wherein the support defines a second opening that is alignable with the first opening when the support is positioned in the door holder; and a locking device that is insertable into the second opening when the support is positioned in the door holder and the second opening is aligned with the first opening to lock the door to the door holder. The locking device is removable from the second opening by pulling on at least a portion of the locking device so that the support may be removed from the door holder.

Clause 2. The door assembly of the preceding clause wherein the locking device comprises a first portion that is engageable with the door holder, a second portion for insertion into the second opening, and a biasing member that urges the second portion into the second opening when the support is positioned in the door holder.

Clause 3. The door assembly of clause 2 wherein the first portion of the locking device is configured to be press fit into the first opening of the door holder.

Clause 4. The door assembly of any of the preceding clauses wherein the locking device comprises a locking pin that is insertable into the first and second openings when the support is positioned in the door holder and the second opening is aligned with the first opening.

Clause 5. The door assembly of clause 4 wherein the locking pin comprises a pin body having a pin axis, a lock element that is movably associated with the pin body so that the lock element is movable in a direction transverse to the pin axis.

Clause 6. The door assembly of any of the preceding clauses further comprising a frame member attached to the hinge, wherein the door has a mass, the door holder and the support of the door each comprise an engagement feature, and the engagement features are engageable with each other when the support is positioned in the door holder so that the door holder supports at least a portion of the mass of the door.

Clause 7. The door assembly of clause 6 wherein the engagement feature of one of the door holder and the support comprises an engagement member, and the engagement feature of the other of the door holder and the support comprises a receptacle that receives the engagement member when the support is positioned in the door holder.

Clause 8. The door assembly of clause 6 wherein the engagement feature of the door holder comprises a pin positioned proximate a lower end of the door holder, and the engagement feature of the support comprises an engagement surface that at least partially defines a slot at a lower end of the support, and wherein the slot is configured to receive the pin and the engagement surface is engageable with the pin when the support is positioned in the door holder.

Clause 9. The door assembly of any of clauses 6-8 where the engagement features are further cooperable with each other to align the first opening and the second opening when the support is positioned in the door holder.

Clause 10. The door assembly of clause 6 wherein the engagement feature of the door holder comprises a surface of the door holder, the support comprises a support body and the engagement feature of the support comprises a support member that projects outwardly from the support body.

Clause 11. The door assembly of clause 6 wherein the door holder comprises a door holder body, the engagement feature of the door holder comprises an engagement member associated with the door holder body, the support comprises a support body and the engagement feature of the support comprises a support member attached to the support body.

Clause 12. The door assembly of clause 11 wherein the engagement member of the door holder comprises a washer, and the support member of the support comprises a plate welded to the support body.

Clause 13. The door assembly of any of clauses 6-12 further comprising an additional hinge attached to the frame member and an additional door holder attached to the additional hinge, and the door comprises an additional support that is receivable in the additional door holder.

Clause 14. The door assembly of clause 13 wherein the additional door holder and the additional support each comprise an alignment feature, and the alignment features are cooperable with each other when the additional support is positioned in the additional door holder so that the additional door holder and the additional support are movable together with respect to a hinge axis of the additional hinge.

Clause 15. The door assembly of any of clauses 13 and 14 wherein the additional hinge is positioned on the frame member below the hinge, and the additional door holder is positioned below the door holder.

Clause 16. The door assembly of any of the preceding clauses wherein the door holder and the support of the door each comprise an alignment feature, and the alignment features are cooperable with each other when the support is positioned in the door holder to align the first and second openings and so that door holder and the support are movable together with respect to a hinge axis of the hinge.

Clause 17. The door assembly of clauses 16 wherein the alignment feature of one of the door holder and the support comprises an alignment member, and the alignment feature of the other of the door holder and the support comprises a receptacle that is configured to receive the alignment member when the support is positioned in the door holder.

Clause 18. The door assembly of clause 17 wherein the alignment member is oriented in a direction transverse to a longitudinal axis of the locking device when the support is positioned in the door holder and the locking device is inserted in the second opening.

Clause 19. A lift comprising a work platform including a frame assembly having a frame member; and the door assembly of any of the preceding clauses, wherein the hinge of the door assembly is attached to the frame member.

Clause 20. The lift of claim 19 further comprising an additional hinge attached to the frame member and an additional door holder attached to the additional hinge, and the door comprises an additional support that is receivable in the additional door holder, wherein the door has a mass, the door holder and the support each comprise an engagement feature, and the engagement features are engageable with each other when the support is positioned in the door holder so that the door holder at least partially supports the mass of the door and so that the locking device does not support any of the mass of the door when the locking device is inserted in the second opening of the support. Furthermore, the additional door holder and the additional support each comprise an alignment feature, and the alignment features are cooperable with each other when the additional support is positioned in the additional door holder so that the additional door holder and the additional support are movable together with respect to a hinge axis of the additional hinge.

Clause 21. Any of the preceding clauses 1-20 in any combination.

While exemplary embodiments are described above, it is not intended that these embodiments describe all possible forms according to the disclosure. In that regard, the words used in the specification are words of description rather than limitation, and it is understood that various changes may be made without departing from the spirit and scope of the disclosure. Additionally, the features of various implementing embodiments may be combined to form further embodiments according to the disclosure. For example, any features of the door assembly 20 may be used with the door assembly 20′, and any features of the door assembly 20′ may be used with the door assembly 20.

What is claimed is:

1. A door assembly comprising:
a hinge;
a door holder attached to the hinge, wherein the door holder defines a first opening;
a door having a support that is receivable in the door holder, wherein the support defines a second opening that is alignable with the first opening when the support is positioned in the door holder; and
a locking device that is insertable into the second opening when the support is positioned in the door holder and the second opening is aligned with the first opening to lock the door to the door holder, wherein the locking device is removable from the second opening by pulling on at least a portion of the locking device so that the support may be removed from the door holder.

2. The door assembly of claim 1 wherein the locking device comprises a first portion that is engageable with the door holder, a second portion for insertion into the second opening, and a biasing member that urges the second portion into the second opening when the support is positioned in the door holder.

3. The door assembly of claim 2 wherein the first portion of the locking device is configured to be press fit into the first opening of the door holder.

4. The door assembly of claim 1 wherein the locking device comprises a locking pin that is insertable into the first and second openings when the support is positioned in the door holder and the second opening is aligned with the first opening.

5. The door assembly of claim 4 wherein the locking pin comprises a pin body having a pin axis, a lock element that is movably associated with the pin body so that the lock element is movable in a direction transverse to the pin axis.

6. The door assembly of claim 1 further comprising a frame member attached to the hinge, wherein the door has a mass, the door holder and the support of the door each comprise an engagement feature, and the engagement features are engageable with each other when the support is positioned in the door holder so that the door holder supports at least a portion of the mass of the door.

7. The door assembly of claim 6 wherein the engagement feature of one of the door holder and the support comprises an engagement member, and the engagement feature of the other of the door holder and the support comprises a receptacle that receives the engagement member when the support is positioned in the door holder.

8. The door assembly of claim 6 wherein the engagement feature of the door holder comprises a pin positioned proximate a lower end of the door holder, and the engagement feature of the support comprises an engagement surface that at least partially defines a slot at a lower end of the support, and wherein the slot is configured to receive the pin and the engagement surface is engageable with the pin when the support is positioned in the door holder.

9. The door assembly of claim 6 where the engagement features are further cooperable with each other to align the first opening and the second opening when the support is positioned in the door holder.

10. The door assembly of claim 6 wherein the engagement feature of the door holder comprises a surface of the door holder, the support comprises a support body and the engagement feature of the support comprises a support member that projects outwardly from the support body.

11. The door assembly of claim 6 wherein the door holder comprises a door holder body, the engagement feature of the door holder comprises an engagement member associated with the door holder body, the support comprises a support body and the engagement feature of the support comprises a support member attached to the support body.

12. The door assembly of claim 11 wherein the engagement member of the door holder comprises a washer, and the support member of the support comprises a plate welded to the support body.

13. The door assembly of claim 6 further comprising an additional hinge attached to the frame member and an additional door holder attached to the additional hinge, and the door comprises an additional support that is receivable in the additional door holder.

14. The door assembly of claim 13 wherein the additional door holder and the additional support each comprise an alignment feature, and the alignment features are cooperable with each other when the additional support is positioned in the additional door holder so that the additional door holder and the additional support are movable together with respect to a hinge axis of the additional hinge.

15. The door assembly of claim 13 wherein the additional hinge is positioned on the frame member below the hinge, and the additional door holder is positioned below the door holder.

16. The door assembly of claim 1 wherein the door holder and the support of the door each comprise an alignment feature, and the alignment features are cooperable with each other when the support is positioned in the door holder to align the first and second openings and so that door holder and the support are movable together with respect to a hinge axis of the hinge.

17. The door assembly of claim 16 wherein the alignment feature of one of the door holder and the support comprises an alignment member, and the alignment feature of the other of the door holder and the support comprises a receptacle that is configured to receive the alignment member when the support is positioned in the door holder.

18. The door assembly of claim 17 wherein the alignment member is oriented in a direction transverse to a longitudinal axis of the locking device when the support is positioned in the door holder and the locking device is inserted in the second opening.

19. A lift comprising:
a work platform including a frame assembly having a frame member; and
the door assembly of claim 1, wherein the hinge of the door assembly is attached to the frame member.

20. The lift of claim 19 further comprising an additional hinge attached to the frame member and an additional door holder attached to the additional hinge, and the door comprises an additional support that is receivable in the additional door holder, wherein the door has a mass, the door holder and the support each comprise an engagement feature, and the engagement features are engageable with each other when the support is positioned in the door holder so that the door holder at least partially supports the mass of the door and so that the locking device does not support any of the mass of the door when the locking device is inserted in the second opening of the support, and wherein the additional door holder and the additional support each comprise an alignment feature, and the alignment features are cooperable with each other when the additional support is positioned in the additional door holder so that the additional door holder and the additional support are movable together with respect to a hinge axis of the additional hinge.
